(19) United States
(12) Patent Application Publication
(10) Pub. No.: US 2013/0170710 A1
(43) Pub. Date: Jul. 4, 2013

(54) METHOD FOR SUPPORTING A USER OF A MOTOR VEHICLE IN OPERATING THE VEHICLE AND PORTABLE COMMUNICATION DEVICE

(71) Applicants: Siav Kuong Kuoch, Saint Maur Des Fosses (FR); Patrick Bonhoure, Annemasse (FR)

(72) Inventors: Siav Kuong Kuoch, Saint Maur Des Fosses (FR); Patrick Bonhoure, Annemasse (FR)

(73) Assignee: VALEO SCHALTER UND SENSOREN GMBH, Bietigheim-Bissingen (DE)

(21) Appl. No.: 13/814,992

(22) PCT Filed: Aug. 9, 2010
(86) PCT No.: PCT/EP10/04870

§ 371 Date: Mar. 8, 2013

(51) Int. Cl. G06K 9/00

(52) U.S. Cl. CPC G06K 9/00832
USPC 382/104

(57) ABSTRACT

The invention relates to a method for supporting a user of a motor vehicle by means of a portable communication device (1) in operating a device (7, 9, 12, 13, 18, 19), in particular an input and/or output device, of the vehicle. An image (4) of an area (6) of the vehicle is captured by means of an imaging device (2) of the portable communication (1) device, wherein the image (4) is received by a control unit (5) of the portable communication device (1). The control unit (5) applies feature recognition to the image (4) regarding a plurality of features stored in the portable communication device (1). The control unit (5) recognizes at least one device (7, 9, 12, 13, 18, 19) of the vehicle in the image (4) on the basis of the stored features. A user guide information (8) is associated with the recognized device (7, 9, 12, 13, 18, 19) and output by the portable communication device (1). The invention also relates to a portable communication device (1).

The present invention relates to a method for supporting a user of a motor vehicle by means of a portable communication device while operating a device, in particular a control device, of the vehicle. The invention also relates to a portable communication device, such as a mobile or smart phone, personal digital assistant and the like.

It is prior art that portable communication devices are used for supporting a user of a motor vehicle. For instance, a mobile phone having a GPS-receiver can be used for the purpose of navigation. Then, the mobile phone has the function of a navigation system.

In the present case, what is of interest is to support a user of a motor vehicle in operating sundry devices of the vehicle, in particular input and output devices, such as push buttons, turning knobs, displays and the like, as well as any vehicle parts, such as a trunk, a wheel, a motor and the like. Different types of user manuals for vehicle devices are known from the prior art: a paper-made user manual and a digital user manual, for instance. Nowadays, the technology used in modern cars is becoming increasingly complex and paper-made user manuals are becoming bigger and bigger. The user is faced with an increasing bulk of information. It becomes difficult to find a clear explanation about a complex device, like a control device located on a car dashboard. On the one hand, it is difficult to quickly find the right user guide information in a paper-made user manual. At the same time, the disadvantage of a digital user manual stored on a CD or the like is that, usually, a stationary personal computer is required to study the user manual. Thus, the user—studying the user manual—is not in the car and cannot see the device of the vehicle.

These days, the number of functions and buttons located on the car dashboard is growing. The number of vehicle parts equally increases. The user cannot easily find an explanation using the paper-made user manual or even the digital one. In particular, the paper-made user manual cannot be found quickly if at all. This problem may occur for instance when renting a car. In the case of a rental car, a user manual may not be available in the vehicle. In other situations the user may not have enough time to study the user manual. The problem also occurs when the user is not familiar with the rental car and the user manual is written in a foreign language. Therefore, it is a challenge to provide a user manual for vehicle devices, in particular input and output devices, which can easily be used in the car, even if the user does not know the name of the device he wishes to obtain information about.

An object of the present invention is to show a way as to how a user of a motor vehicle can quickly be supported by means of a portable communication device in operating a device, in particular a control device, of the vehicle, in particular even if the user does not know the name of the (control) device.

According to the present invention, this problem is solved by means of a method with the features according to patent claim 1 as well as by means of a portable communication device with the features of patent claim 11. Advantageous embodiments of the invention are subject matter of the dependent claims and of the description.

A method according to the present invention serves to assist a user of a motor vehicle while operating a device, in particular an input and/or an output device, of the vehicle. A portable communication device is used for supporting the user. An image of an area of the vehicle is captured by means of an imaging device of the portable communication device, and the image is received by a control unit of the portable communication device. A feature recognition is applied to the image by the control unit in respect of a plurality of features stored in the portable communication device. At least one device of the vehicle, in particular a control device, located in the captured area is recognized on the basis of the stored features. A user guide information—i.e. operating or user manual information—is associated with the recognized device. Then, the associated user guide information is output by the portable communication device.

So, according to the present invention, a piece of user guide information and thus a guide manual for at least one device of the vehicle is stored in the portable communication device. Also, a plurality of features regarding the at least one device of the vehicle is stored in the portable communication device. On the basis of the stored features, the control unit can recognize the at least one device in the image captured by the imaging device. Then, the user gets the user guide information he requires. In this way, a user-friendly user manual can be provided which is very easy to use. The user is provided with the required user guide information very quickly: It suffices to capture an image, and the user guide information can be presented automatically. The method can also be performed at low cost since a standard portable communication device—such as a mobile phone, for instance—can be used for supporting the user.

The portable communication device may, for instance, be a mobile phone (smart phone) or a mobile personal computer, like a personal digital assistant, organizer or the like. Such devices nowadays have high computing power and usually have an imaging device, like a digital camera.

The term “input device”—according to the present invention—in particular comprises control devices, i.e. devices for controlling different functions in the vehicle, like push buttons, rotary knobs and the like. Thus, a control device is a device operated by the user. The term “output device”—according to the present invention—in particular comprises display devices and other devices for outputting information or messages. However, the present invention is not limited to input and/or output devices; the term “device” also comprises other vehicle parts, such as a trunk, a vehicle wheel, a motor and the like. Also for these devices, the associated user guide information can be output by the portable communication device.

So, according to the present invention, the associated user guide information is output by the portable communication device. In principle, the user guide information can be output by a loudspeaker of the portable communication device—then, the user guide information is output as a voice signal, in particular a speech signal. However, it turned out to be advantageous to display the user guide information on a display device of the portable communication device. In this way, a user-friendly user manual is provided by means of the portable communication device; the user obtains the information displayed on the display device of the portable communication device. For instance, text information in respect of the recognized device may be displayed on the display device.

Additionally, the recognized device can be displayed on the display device together with the associated user guide information. In one embodiment, the captured image can be displayed on the display device, and this image can be partly covered or overlaid by the user guide information. Then, the user can easily associate the user guide information with the recognized vehicle device. In particular, this embodiment turned out to be very advantageous when a plurality of vehicle devices are recognized by the control unit and user guide information is displayed for each recognized device. For instance, a link line connecting the displayed recognized device with the associated user guide information may be displayed on the display device. However, the associated user guide information shown together with the recognized device may also be indicated in another way.

In one embodiment, an augmented reality process can be used: The imaging device (such as a camera) can capture a video stream, and this video can be displayed on the display device in real time. Also in real time, a vehicle device can be recognised and the associated user guide information can be displayed. This means that the user guide information can overlay the real time video displayed on the display device. Then, the user does not have to actively capture a photo but a video mode suffices for the recognition of the vehicle device.

In one embodiment, on the basis of the captured image a further device—in particular a further input device and/or output device—of the vehicle located outside the captured area of the vehicle is recognized by the control unit. Then, information regarding said further device can be output by the portable communication device. For instance, this information can be displayed on the display device of the portable communication device. In this way, even if a vehicle device is located outside the captured area and thus is not captured by the imaging device, this device may be recognized by the control unit, namely on the basis of the captured image and the stored features of the captured area. Then, the user also gets information regarding the vehicle device which is not pictured in the captured image.

For example, user guide information associated with said further device can be output by the portable communication device. In particular, this user guide information is displayed on the display device of the portable communication device. In this way, the user can also be guided through operating the vehicle device that is not captured by the imaging device. Additionally or alternatively, information about a position of said further device relative to the device located within the captured area can be output by the portable communication device. In particular, this information is displayed on the display device. For example, an arrow may be displayed on the display device; the arrow can indicate the location direction of the recognized device located outside the captured area. Also, a name of the vehicle device located outside the captured area can be displayed next to the arrow indicating the location direction. Therefore, the user can be informed about the presence and the type of vehicle devices which are located outside the captured area and thus are not pictured in the captured image.

For the purpose of recognizing a vehicle device located outside the captured area, the control unit can determine a current absolute position of the portable communication device within a vehicle coordinate system and/or an orientation of the portable communication device. The absolute position and/or the orientation can, for instance, be calculated by the control unit depending on the absolute position of the at least one recognized device and/or depending on scale factor information determined on the basis of the captured image. For example, the absolute position of the at least one recognized device can be stored in the portable communication device. Once the absolute position and/or the orientation of the portable communication device is/are known, the position of other vehicle devices relative to the recognized device and/or relative to the portable communication device can be determined by the control unit.

So, in one embodiment, an absolute position of the at least one recognized device of the vehicle within a vehicle coordinate system is stored in the portable communication device, wherein a current absolute position and/or an orientation of the portable communication device is calculated by the control unit in dependency on the absolute position of the at least one recognized device and/or in dependency on scaling information determined on the basis of the captured image. As has been set out above, in this way the control unit can determine a relative position of other vehicle devices located outside the captured area, and the control unit can output information in respect of these devices. Also, calculating the current absolute position and/or the orientation of the portable communication device allows to display the associated user guide information in a three-dimensional way. For instance, the user guide information can be displayed in such a way that the displayed information is in line with the associated vehicle device. In this embodiment, the current absolute position and/or the orientation of the portable communication device can be considered while displaying the user guide information.

For applying the feature recognition, several methods known from the prior art can be used. For instance, the scale-invariant feature transform (SIFT) can be used for applying the feature recognition. Alternatively, the speeded-up robust features method (SURF) can be applied. These are algorithms to detect and describe local features in images. In a learning or offline mode, points of interest on vehicle devices can be extracted to provide a feature description of the devices. This description is extracted from a training image and can then be used to identify the vehicle objects when attempting to locate the devices in a test image containing many other objects. The set of features extracted from the training image can be stored in the portable communication device so that the control unit can apply the feature recognition to any image in respect of the set of features stored in the portable communication device. The advantage of said methods (SIFT and SURF) is that they are reliable over other methods and have high efficiency and a high speed degree.

So, user guide information associated with the recognized vehicle device is output by the portable communication device. Diverse information can be associated with the at least one vehicle device. For instance, diverse information associated with the recognized vehicle device can be output in dependency on a user input. For the at least one vehicle device, a user manual can be provided in form of a database. Such a database can comprise diverse user manual information regarding the at least one vehicle device, for instance the following pieces of information: an identification or a name of the device and/or a category of the device and/or a subcategory of the device and/or a description of the device and/or an information folder “see also” and/or information about the position of the device within a coordinate system of the vehicle.

A plurality of devices—in particular input and/or output devices—of the vehicle can be subdivided into groups of devices of the same category. Then, after at least one device is recognized by the control unit, user guide information can be output for this recognized device as well as for at least one further device from the same group. In this way, the user is provided with the information not only about the recognized device, but also about other similar devices of the same category. For instance, once a control device for turning on and off a multimedia center of the vehicle is recognized by the control unit, user guide information associated with this control device can be output together with information regarding a control device for controlling the volume.

So, for the at least one vehicle device a user manual and/or a set of features can be provided in the form of a database. Furthermore, the functionality of processing an image and applying the feature recognition with respect to the set of features as well as the functionality of associating the user guide information with the vehicle device can be provided in the form of a software application. Such software can be installed by the user on the portable communication device. Then, the application can be started upon an input of the user. The database of the user manual can also be an online version of the user manual that is up to date. Then, the portable communication device can download and store the respectively latest version of the database or it can access the online version of the database which is stored on a host server without storing the database on the portable communication device. For instance, each time the application is started the portable communication device can check online whether the latest version of the database is downloaded or not. If necessary, the portable communication device can then download the latest version of the database. Also, the user can be given the opportunity to download different versions of the database, i.e. for different types of cars—for example in the case of a rental car. In one embodiment, the database for the user's own car may be stored on the portable communication device, whereas the portable communication device can access databases for other types of cars online, namely on the host server.

According to the present invention, there is also provided a portable communication device comprising an imaging device—like a digital camera—for capturing an image of an area of a motor vehicle as well a control unit for receiving the captured image. The control unit is adapted to apply feature recognition to the image regarding a plurality of features stored in the portable communication device and to recognize at least one device of the vehicle in the image on the basis of the stored features. The control unit is adapted to output user guide information associated with the recognized device.

The embodiments presented as preferable with regard to the method according to the invention and their advantages apply to the portable communication device according to the invention analogously. Further features of the invention may be gathered from the claims, the figures and the description of the figures. The features and feature combinations previously mentioned in the description as well as the features and feature combinations mentioned further along in the description of the figures and/or shown in the figures alone are usable not only in the respectively indicated combination, but also in other combinations and alone without departing from the scope of the invention.

The invention is now set out in more detail on the basis of individual embodiments as well as by making reference to the enclosed drawings.

These show in:

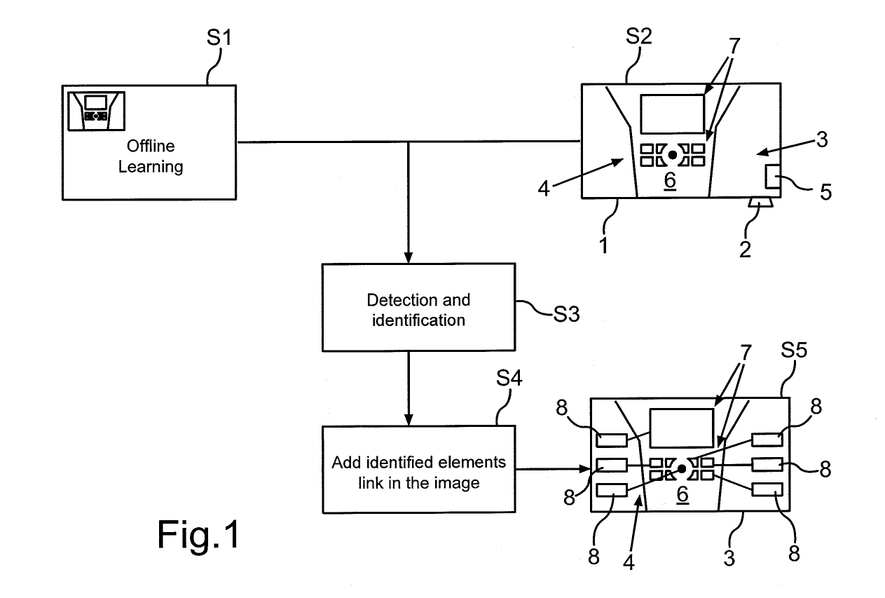

FIG. 1 a flow chart of a method according to an embodiment of the present invention;

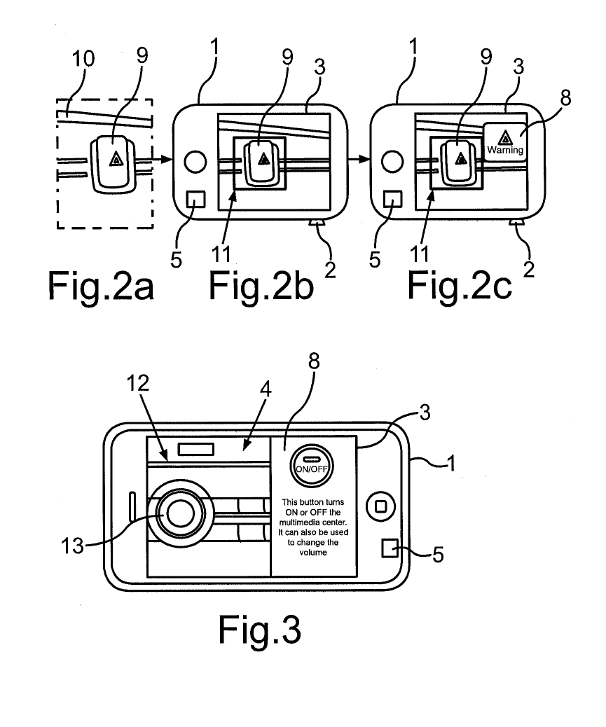

FIGS. 2a to 2c a schematic representation of a control device of a vehicle and a portable communication device with said control device displayed on a display device;

FIG. 3 a schematic representation of the portable communication device, wherein a recognized control device of the vehicle is displayed together with associated user guide information;

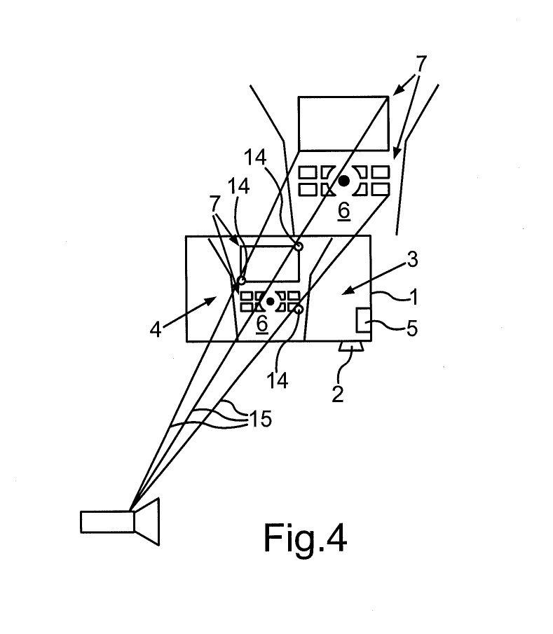

FIG. 4 a schematic representation of a control and display device of the vehicle as well as the portable communication device, wherein a method according to one embodiment of the invention is explained in greater detail;

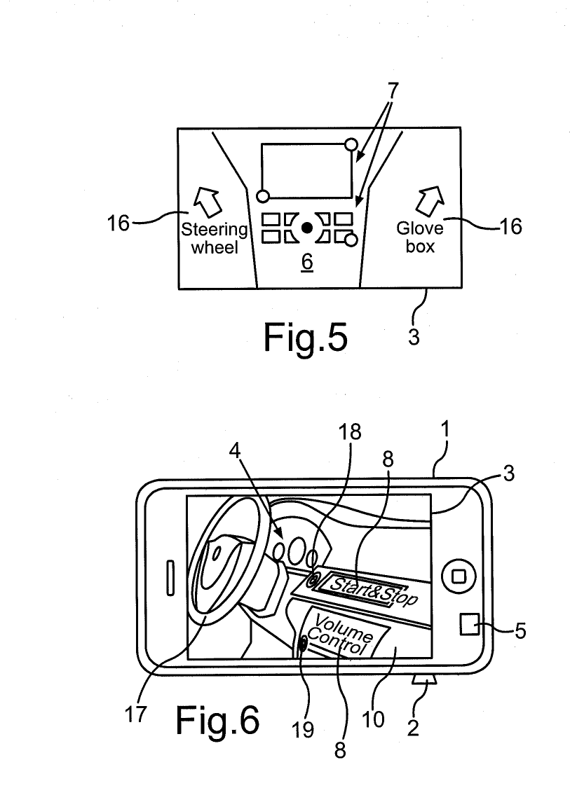

FIG. 5 a schematic representation of the portable communication device, wherein the control and display device of the vehicle is displayed together with information regarding a vehicle device not displayed on the display device; and

FIG. 6 a schematic representation of the portable communication device, wherein a plurality of control devices together with associated pieces of user guide information are displayed in a three-dimensional way.

Referring now to FIG. 1, a flow chart of a method according to one embodiment of the present invention is explained: Firstly, in a step S1, a training image of an area of a motor vehicle—for example, a dashboard of the vehicle—is captured by a digital camera. For all control devices in the training image, e.g. push buttons, turning knobs and the like, points of interest on each control device are extracted to provide a feature description of each control device.

Features of all control devices being located on the dashboard are stored. Here, the scale-invariant feature transform is applied. Then, software with an algorithm for applying a feature recognition regarding the stored features is provided. The software is installed on a portable communication device 1.

The portable communication device 1 can be a smart phone or a personal digital assistant. The portable communication device 1 comprises a digital camera 2, i.e. an imaging device for capturing an image. The portable communication device 1 also comprises a display 3 that can, for instance, be a touch screen. Furthermore, the portable communication device 1 comprises a control unit 5 which can have a digital signal processor as well as a microcontroller and a memory unit. In the memory unit, said software for applying feature recognition is stored together with the features of said control devices of the vehicle.

Moreover, in step S1 a user manual for said control devices of the vehicle is stored in the memory unit of the control unit 5. For each control device, the following pieces of user guide information can be stored in the control unit 5:
an identification of the control device, i.e. its name,
a category of the control device, for instance: “audio device”, “video device” or “driver assistance device”,
a subcategory of the control device,
a description of the function of the control device,
a folder “see also”, for instance user guide information about a further control device of the same category or of the same subcategory, and
an absolute position of the control device within a vehicle coordinate system.

All these pieces of information are stored in the memory unit of the control unit 5 for each control device of the car. Alternatively, such database can be stored on a host server and accessed online by the portable communication device 1. Then, the database is always up to date. If the database is stored on the portable communication device 1, each time when the said software application is started the control unit 5 can check online whether the stored database is of the latest version or not. If necessary, the control unit 5 can download and store the latest version of the database.

In the next step S2, an image 4 of an area 6 of the vehicle is captured by the camera 2. Then, the image 4 is displayed on the touch screen 3. The area 6 is an inside area of the vehicle and comprises a dashboard of the vehicle. There is a plurality of control devices 7 located on the dashboard of the vehicle. The control devices 7 can comprise push buttons and the like.

In step S2, alternatively, a video mode of the portable communication device 1 can be activated. In such video mode a video stream is captured by the camera 2 and displayed on the display 3 in real time. The user does not have to actively capture any image.

In the next step S3, the control unit 5 applies feature recognition to the captured image 4 or an image 4 of the video stream (video mode) regarding the stored features. On the basis of the stored features, the control unit 5 recognizes all control devices 7 in the image 4.

In the next step S4, for each of the recognized control devices 7 user guide information is associated from said data base. Each control device 7 is associated with its own user manual and thus with own pieces of information about the identification, category, subcategory, description, “see also” and the absolute position.

Finally, in step S5, the captured image 4 is displayed on the touch screen 3 together with a piece of user guide information 8 for each recognized control device 7. Alternatively, the pieces of information can overlay the real time video stream in the video mode, like in an augmented reality process. The displayed user guide information can be one of said pieces of information: identification, category, subcategory, description, “see also”, or the position.

In one embodiment, the user may choose one of the recognized control devices 7 and obtains the not displayed pieces of information regarding the chosen device 7. For instance, the user may touch the touch screen 3 at the position of the displayed user guide information 8 to enter the whole user manual of the associated control device 7.

Referring now to FIGS. 2a to 2c, a push button 9 located on a dashboard 10 of the vehicle can be recognized by the control unit 5, and user guide information can be displayed on the touch screen 3. FIG. 2a shows the push button 9 located on the dashboard 10. The push button 9 serves for switching on and off the hazard or warning flasher of the vehicle. FIG. 2b shows the portable communication device 1 and an area of detection 11 comprising the push button 9 displayed on the touch screen 3. The push button 9 is recognized by the control unit 5, and user guide information 8 is associated with the recognized push button 9. FIG. 2c shows the portable communication device 1 according to FIG. 2b, wherein the user guide information 8 is displayed together with the push button 9.

Another example is shown in FIG. 3. An image representing a multimedia center 12 of the vehicle is displayed on the touch screen 3 of the portable communication device 1. The multimedia center 12 comprises a button 13 that is recognized by the control unit 5 and indicated on the touch screen 3. User guide information 8 is associated with the button 13 and displayed together with the multimedia center 12. Here, the function description of the button 13 is displayed as user guide information 8.

As has been set out above, information about the absolute position of the control devices is stored in the portable communication device 1. With reference to FIG. 4, a method is explained in more detail as to how a current absolute position and/or a current orientation of the portable communication device 1 within the coordinate system of the vehicle can be computed by the control unit 5. The inside area 6 of the vehicle comprising the plurality of the control devices 7 is captured by the camera 2 of the portable communication device 1. The image 4 is displayed on the touch screen 3. The control unit 5 determines a scale factor of the captured image 4 in respect of said training image, i.e. in respect of the stored features. For instance, a distance between points of interest 14 may be used for determining the scale factor. The scale factor varies depending on the distance between the portable communication device 1 and the captured area 6 of the vehicle, as it is indicated with the help of lines 15. On the basis of the captured image 4, i.e. on the basis of the points of interest 14 as well as in dependency on the absolute position of the control devices 7 stored in the memory unit, the control unit 5 can determine the current absolute position as well as the orientation of the portable communication device 1 within the coordinate system of the vehicle.

Once the absolute position and the orientation are known, the position of other devices of the vehicle located outside the captured area 6 relative to the portable communication device 1 can be determined by the control unit 5. Then, referring to FIG. 5, information 16 associated with these further devices of the vehicle can be displayed on the touch screen 3 of the portable communication device 1. As shown in FIG. 5, arrows indicating the direction of the location of these devices can be displayed on the touch screen 3 of the portable communication device 1. In the embodiment shown in FIG. 5 the direction of the location of a steering wheel as well as a gloves box is indicated by the portable communication device 1. Also, user guide information regarding these devices (steering wheel and gloves box) can be displayed on the touch screen 3.

In one embodiment, if there is no information about the absolute position of the control devices 7 stored in the control unit 5, information about a position of the devices of the vehicle relative to each other can be stored in the control unit 5. Also, in this case, the control unit 5 can display the information 16 associated with the devices located outside the captured area 6.

Once the absolute position and the orientation of the portable communication device 1 within the coordinate system of the vehicle are known, the user guide information 8 associated with the recognized control device 7 can be displayed in a three-dimensional way, as shown in FIG. 6. An image 4 captured by the camera 2 is displayed on the touch screen 3. A steering wheel 17 as well as a dashboard 10 is shown in the image 4. The control unit 5 recognizes a “Start and Stop” button 18 for switching on and off the vehicle motor as well as a button 19 for controlling the volume. For each recognized button 18, 19 user guide information 8 is displayed in the form of text. The user guide information is displayed in a three-dimensional way. In this case, the user guide information 8 is displayed in line with the extending direction of the dashboard 10, i.e. horizontally.

1. A method for supporting a user of a motor vehicle by means of a portable communication device in operating an input and/or output device, of the vehicle, comprising:
capturing an image of an area of the vehicle by means of an imaging device of the portable communication device, wherein the image is received by a control unit of the portable communication device;
applying a feature recognition to the image by the control unit regarding a plurality of features stored in the portable communication device and recognizing at least one device of the vehicle in the image on the basis of the stored features as well as associating a user guide information with the recognized device, and
outputting the associated user guide information by the portable communication device.

2. The method according to claim 1, wherein the user guide information is displayed on a display device of the portable communication device.

3. The method according to claim 2, wherein the captured image is displayed on the display device together with the associated user guide information.

4. The method according to claim 2, wherein a video stream captured by the imaging device and the user guide information are displayed on the display device in real time, such that the video stream is overlaid with the user guide information.

5. The method according to claim 1, wherein on the basis of the captured image a further device of the vehicle located outside the captured area of the vehicle is recognized by the control unit, and information regarding said further device is output by the portable communication device.

6. The method according to claim 5, wherein guide information associated with said further device is output by the portable communication device.

7. The method according to claim 5, wherein information about a position of said further device relative to the device located within the captured area is output by the portable communication device.

8. The method according to claim 2, wherein an absolute position of the at least one recognized device within a vehicle coordinate system is stored in the portable communication device, wherein a current absolute position and/or an orientation of the portable communication device is calculated by the control unit in dependency on the absolute position of the at least one recognized device.

9. The method according to claim 8, wherein the current absolute position and/or the orientation of the portable communication device is considered by the control unit when displaying the user guide information.

10. The method according to claim 1, wherein the Scale-Invariant Feature Transform (SIFT) or the Speeded Up Robust Features Method (SURF) is used for applying the feature recognition.

11. A portable communication device, comprising:
an imaging device for capturing an image of an area of a motor vehicle; and
a control unit for receiving the captured image,
wherein the control unit is configured to apply a feature recognition to the image regarding a plurality of features stored in the portable communication device and to recognize at least one device of the vehicle in the image on the basis of the stored features as well as to outputting a user guide information associated with the recognized device.
